(19) United States
(12) Patent Application Publication
(10) Pub. No.: US 2016/0349602 A1
(43) Pub. Date: Dec. 1, 2016

(54) MOUNTING MECHANISM

(71) Applicant: IKEGPS Group Limited, Wellington (NZ)

(72) Inventors: Leon Mathieu LAMMERS VAN TOORENBURG, Wellington (NZ); David Neil LOVEGROVE, Christchurch (NZ); Carl Benjamin MENARY, Christchurch (NZ); Ross Hughan DAWSON, Christchurch (NZ); Oliver Charles Graham JACKSON-HILL, Christchurch (NZ)

(21) Appl. No.: 15/168,996

(22) Filed: May 31, 2016

Related U.S. Application Data
(60) Provisional application No. 62/169,543, filed on Jun. 1, 2015.

(51) Int. Cl. G03B 17/56; H04N 5/232; G03B 13/20; F16M 13/02; F16B 2/12

(52) U.S. Cl. CPC G03B 17/566; F16M 13/022; F16B 2/12; G03B 13/20; G03B 17/568; H04N 5/23209

(57) ABSTRACT

The invention relates to a mounting mechanism for mounting an auxiliary device, such as a rangefinder, to a mobile device. The mounting mechanism includes an interface surface with formations to engage with a surface of the mobile device to maintain a desired orientation between the mobile device and the auxiliary device. The mounting mechanism also includes two or more arms which may be moved synchronously towards each other to clamp a mobile device engaged with the interface surface so as to maintain the mobile device centralised with respect to the interface surface.

This application claims benefit of U.S. Provisional Application No. 62/169,543, filed 1 Jun. 2015 and which application is incorporated herein by reference. To the extent appropriate, a claim of priority is made to the above disclosed application.

### FIELD OF THE INVENTION

The invention relates to a mounting mechanism for mounting an auxiliary device, such as a rangefinder, to a mobile device.

### BACKGROUND TO THE INVENTION

Reference to any prior art in this specification does not constitute an admission that such prior art forms part of the common general knowledge.

The Applicant's WO2012/081995 describes a data capture method using a rangefinder module and a mobile device including a camera and a display (e.g. a mobile phone). The rangefinder may be secured to the mobile device in a number of different ways. The simplest of these is a permanent connection e.g. with adhesive. However more sophisticated mounting mechanisms which provide releasable connections between the rangefinder and the mobile devices may be advantageous.

Various mounting mechanisms have been suggested to releasably mount mobile devices to other portable modules (e.g. to stands). However attachment of a rangefinder to a mobile device requires more precise orientation and positioning of the device relative to the rangefinder in order to ensure accurate calibrated measurements. In particular, prior mounting mechanisms have failed to adequately centralise rangefinders relative to the mobile devices and to align the range finder optical axis with the optical axis of the mobile device's camera. In particular, prior mounting mechanisms have failed to adequately achieve mounting with the correct angular and lateral alignment for a variety of phone shapes and/or sizes.

It is an object of the invention to provide an improved mounting mechanism, or at least to provide the public with a useful choice.

### SUMMARY OF THE INVENTION

In a first aspect the invention provides a mounting mechanism for mounting an auxiliary device to a mobile device, the mounting mechanism including:
an interface surface having formations positioned such as to engage with a surface of the mobile device so as to maintain the mobile device in a desired orientation relative to the auxiliary device; and
two or more arms that may be moved synchronously towards each other to clamp a mobile device engaged with the interface surface so as to maintain the mobile device centralised with respect to the interface surface.

Preferably the mobile device includes a camera with a camera optical axis and the auxiliary device is a rangefinder having a rangefinder optical axis and the interface surface has formations positioned such as to engage with a surface of the mobile device so as to maintain the camera optical axis generally parallel with the rangefinder optical axis. Preferably the formations are arranged on the interface surface so as to maintain the rangefinder optical axis substantially parallel with the camera optical axis for a range of mobile device profiles. Preferably the mobile device profiles include two or more of a convex profile; concave profile; and a flat profile. A housing may encase the rangefinder.

The mobile device may include a camera with a camera optical axis and the auxiliary device may include a laser pointer having a laser optical axis and the interface surface has formations positioned such as to engage with a surface of the mobile device so as to maintain the camera optical axis generally parallel with the laser optical axis.

The mobile device may include a camera with a camera optical axis and the auxiliary device may be an acoustic sensor having an acoustic axis and the interface surface has formations positioned such as to engage with a surface of the mobile device so as to maintain the camera optical axis generally parallel with the acoustic axis.

The mobile device may include a camera with a camera optical axis and the auxiliary device may include an orientation sensor having an orientation axis and the interface surface has formations positioned such as to engage with a surface of the mobile device so as to maintain the camera optical axis generally parallel or normal to the orientation axis.

Preferably the interface surface has formations positioned such as to engage with a surface of the mobile device and wherein the formations include two parallel ribs.

Preferably each rib has a central section and an outer ramp section sloping towards edges of the mounting mechanism.

Alternatively, each rib may have a central section and an outer flat platform, lower than the central section.

Preferably each rib has an inner ramp section sloping towards an opposite rib.

Preferably the ribs are between 2 to 4 mm high.

Preferably opposite inner edges of the ribs are spaced between 20 mm to 70 mm apart.

The interface surface may have formations positioned such as to engage with a surface of the mobile device and wherein the formations include a plurality of symmetrically arranged pads.

Preferably the two or more arms move synchronously by a rack and pinion mechanism.

Alternatively, the two or more arms move synchronously by a piston and spring mechanism.

Preferably the arms are retained in engagement when clamped upon a mobile device and released by a release mechanism. Preferably the release mechanism is activated by one of: a release button; further forcing the clamp arms together; and forcing the clamp arms apart with a force greater than a release threshold force.

Preferably each arm inclines towards the other towards its distal end to assist retention of a mobile device.

Preferably the interface surface has formations positioned such as to engage with a surface of the mobile device and wherein the formations are formed of a resilient material.

### BRIEF DESCRIPTION OF THE DRAWINGS

The invention will now be described by way of example only, with reference to the accompanying drawings, in which:

FIG. 1 shows a side view of a mounting mechanism according to an embodiment of the invention.

FIG. 2a shows a perspective view of the mounting mechanism shown in FIG. 1 with arms retracted, according to an embodiment of the invention.

FIG. 2b shows a front view of the mounting mechanism of FIG. 2a.

FIG. 2c shows a back view of the mounting mechanism of FIG. 2a.

FIG. 3a shows a perspective view of a mounting mechanism 1, with arms extended.

FIG. 3b shows a front view of the mounting mechanism of FIG. 3a.

FIG. 3c shows a back view of the mounting mechanism of FIG. 3a.

FIG. 4a shows a an arrangement of formations on an interface surface of a mounting mechanism according to an embodiment of the invention.

FIG. 4b shows an arrangement of formations on an interface surface of a mounting mechanism according to another embodiment of the invention.

FIG. 4c shows an arrangement of formations on an interface surface of a mounting mechanism according to another embodiment of the invention.

FIG. 4d shows a cross sectional view along line A-A of a mounting mechanism according to an embodiment of the invention.

FIG. 4e shows a cross sectional view along line A-A of a mounting mechanism according to another embodiment of the invention.

FIG. 4f shows a cross sectional view along line A-A of a mounting mechanism according to another embodiment of the invention.

FIG. 4g shows a cross sectional view along line A-A of a mounting mechanism according to another embodiment of the invention.

FIG. 4h shows a cross section view along line A-A of a mounting mechanism according to another embodiment of the invention.

FIG. 5a shows a perspective view of mounting arms according to an embodiment of the invention.

FIG. 5b shows a front view of the mounting arms of FIG. 5a.

FIG. 6a shows a side view of a mounting mechanism mounted to a mobile device and rangefinder according to an embodiment of the invention.

FIG. 6b shows a perspective view of the mounting mechanism of FIG. 6a.

FIG. 7 shows front views of attachment of a mounting mechanism to a range of different mobile devices according to an embodiment of the invention.

FIG. 8 shows a front view of attachment of a mounting mechanism to a large mobile device according to an embodiment of the invention.

FIG. 9 shows an exploded view of a mounting mechanism according to an embodiment of the invention.

### DETAILED DESCRIPTION

The invention generally relates to a mounting mechanism for mounting an auxiliary device, such as a rangefinder to a mobile device. Whilst the invention will be described in detail using the example of a rangefinder it will be appreciated that the invention may be applied to a range of other auxiliary devices requiring alignment with a mobile device.

Such a mounting mechanism may be used to secure a rangefinder in a fixed position relative to a sensor, such as the mobile device's camera for use in measuring methods such as the one described in the Applicant's prior application WO2012/081995.

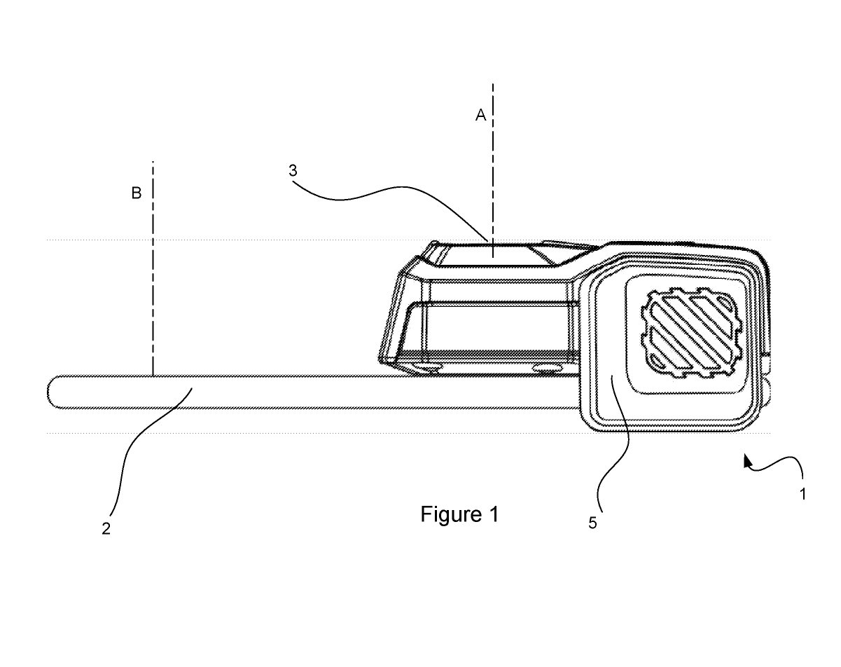

FIG. 1 shows a side view of a mounting mechanism 1 according to an embodiment of the invention. The mounting mechanism 1 attaches a mobile device 2, to a rangefinder 3. The rangefinder 3 has an optical axis A arranged to be substantially perpendicular to the interface surface of rangefinder 3. The rangefinder 3 may be a laser rangefinder, or any other suitable rangefinder which measures the distance from the rangefinder to a target along optical axis A of the rangefinder.

The mobile device may be, but is not limited to a mobile phone, tablet, or a PDA. In FIG. 1, the mobile device 2 is a smartphone. The mobile device includes a camera 10 with a camera optical axis B, substantially perpendicular to the interface surface of the mobile device. Preferably the camera is on the reverse side of the screen of the mobile device so that a user can control the device and view camera output simultaneously with image capture and/or range finding.

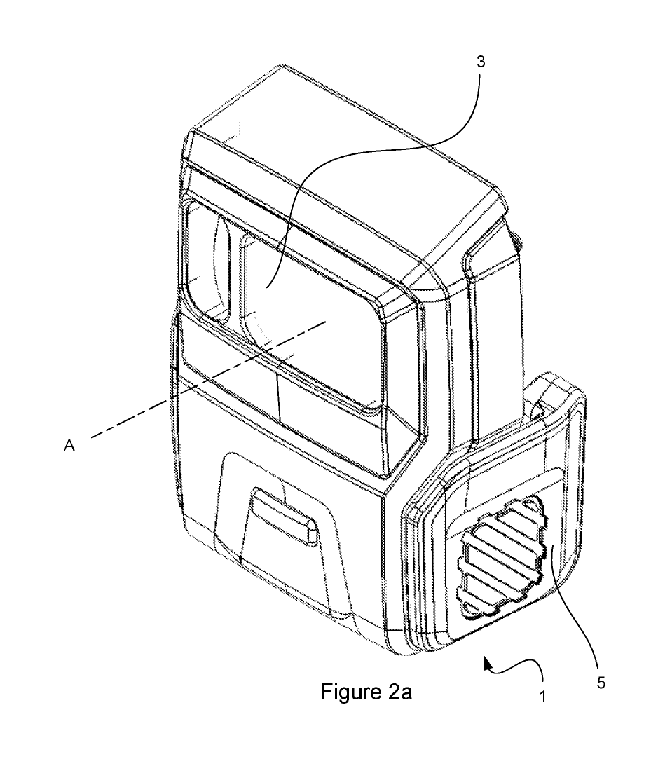

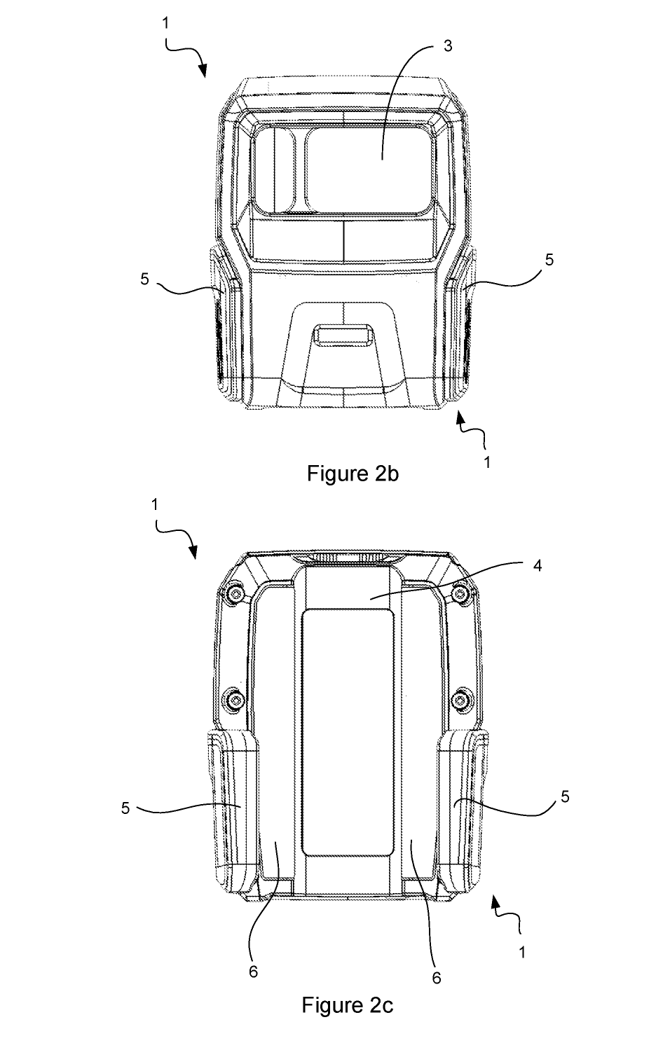

FIGS. 2a, 2b and 2c show perspective, front and back views respectively of mounting mechanism 1 for mounting a rangefinder 3 to a mobile device. The mounting mechanism includes an interface surface 4 having formations 6 positioned such as to engage with a surface of the mobile device so as to maintain the camera optical axis generally parallel with the rangefinder optical axis.

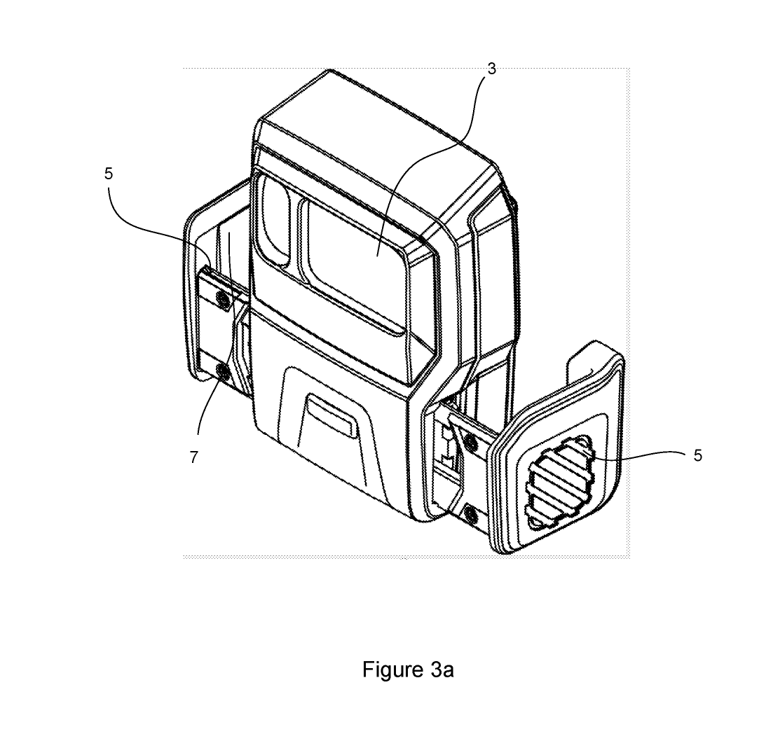

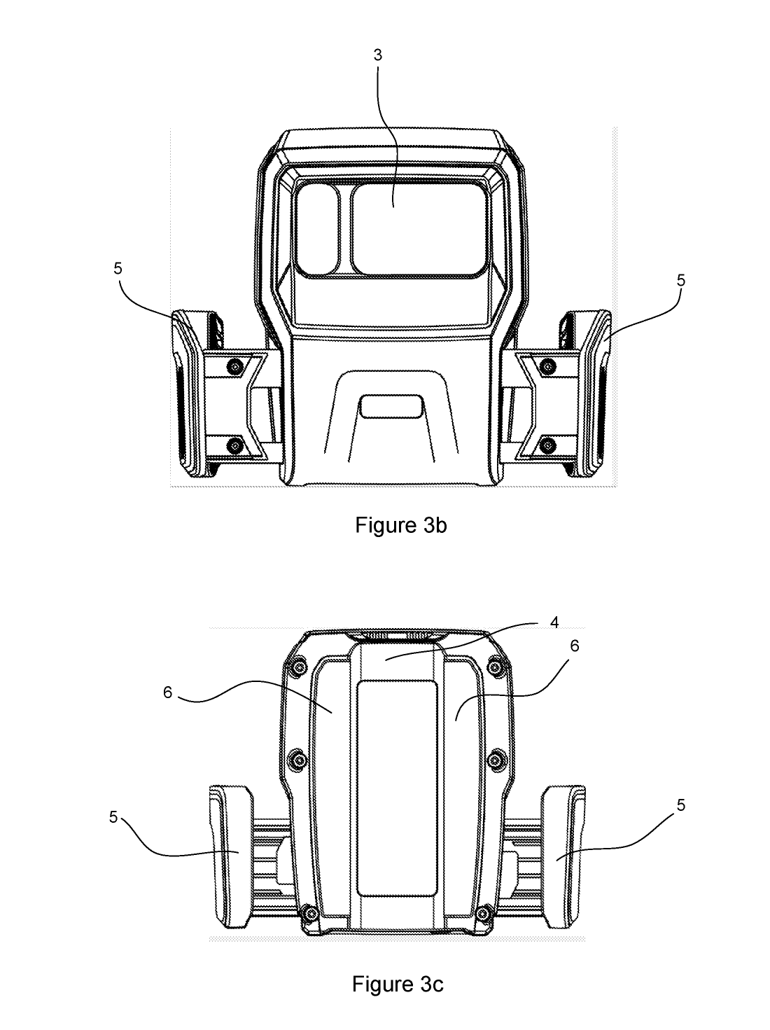

The mounting mechanism also includes two arms 5 that may be moved synchronously towards each other to clamp a mobile device engaged with the interface surface 4. The arms 5 clamp the mobile device so as to maintain the mobile device centralised with respect to the interface surface 4. In FIGS. 2a to 2c, the arms 5 of the mounting mechanism 1 are in a clamped (i.e. contracted) position. FIGS. 3a, 3b and 3c show perspective, front and back views respectively of a mounting mechanism for mounting a rangefinder to a mobile device, with the arms 5 of the mounting mechanism in an extended position.

Although the mounting mechanisms will be described primarily with reference to mounting a rangefinder to a mobile device, the invention is not limited in this respect. The mounting mechanism may be used to mount any suitable auxiliary device, in particular a device with a visual/acoustic or other axis to be aligned in a fixed orientation with respect to the camera optical axis of the mobile device.

The auxiliary device may include a laser pointer (optionally in addition to a laser rangefinder) having a laser pointer optical axis. An interface surface of the mounting mechanism may include formations positioned such as to engage with a surface of the mobile device so as to maintain the camera optical axis generally parallel with the laser pointer optical axis. This laser pointer may assist a user to aim the mobile device at a target to be measured.

In another embodiment, the auxiliary device may include an acoustic sensor having an acoustic axis and the interface surface may have formations positioned such as to engage with a surface of the mobile device so as to maintain the camera optical axis generally parallel with the acoustic axis.

In yet another embodiment, the auxiliary device may include an orientation sensor having an orientation axis (e.g. a gyroscope/3D compass/tilt sensor). The interface surface may include formations positioned such as to engage with a surface of the mobile device so as to maintain the camera optical axis generally parallel or normal to the orientation axis.

Preferably the formations are arranged on the interface surface so as to maintain the auxiliary device axis/axes in a desired orientation with respect to the camera optical axis for a range of mobile device profiles.

### Formations

As mentioned above, the mounting mechanism includes formations configured to allow a range of mobile electronic devices of varying shapes and configurations to be maintained in an optimal alignment. Specifically, the formations are positioned such as to engage with a surface of the mobile device so as to maintain the camera optical axis B generally parallel with the rangefinder optical axis A. This is particularly useful for attachment to mobile devices and/or mobile device cases which may have curved surfaces. The arms 5 centralize the mobile device on the formations and the formations ensure that angular alignment of the camera optical axis and range finder optical axis is maintained (i.e. avoiding lateral tilt).

In the embodiment shown in FIGS. 2c and 3c, the mounting mechanism includes two identical formations 6, which are substantially rectangular in shape, and are disposed symmetrically on either side of the mounting mechanism, near the arms of the mounting mechanism. When a mobile device with a curved surface is placed between the arms 5 of the mounting mechanism, the formations 6 cradle the mobile device towards a centralised position, with the centre of the mobile device being substantially aligned with the centre of the mounting mechanism (in the centre of the recess formed between the two formations 6). The centering of the arms 5 and cradling of the ribs 6 ensures that the optical axis of the camera of the mobile device is substantially aligned with the optical axis of the rangefinder.

Although the embodiment in FIGS. 2c and 3c shows two formations integrally formed with the mounting mechanism, the invention is not limited in this respect, and any suitable formation positions and/or configurations which achieve the purpose of aligning the optical axis of the camera of a mobile device with the optical axis of the rangefinder are envisaged. Suitable formations may include (but are not limited to) raised surfaces, ribs, pads, bumps or protrusions. Preferably, the formations are symmetrically arranged about the interface surface.

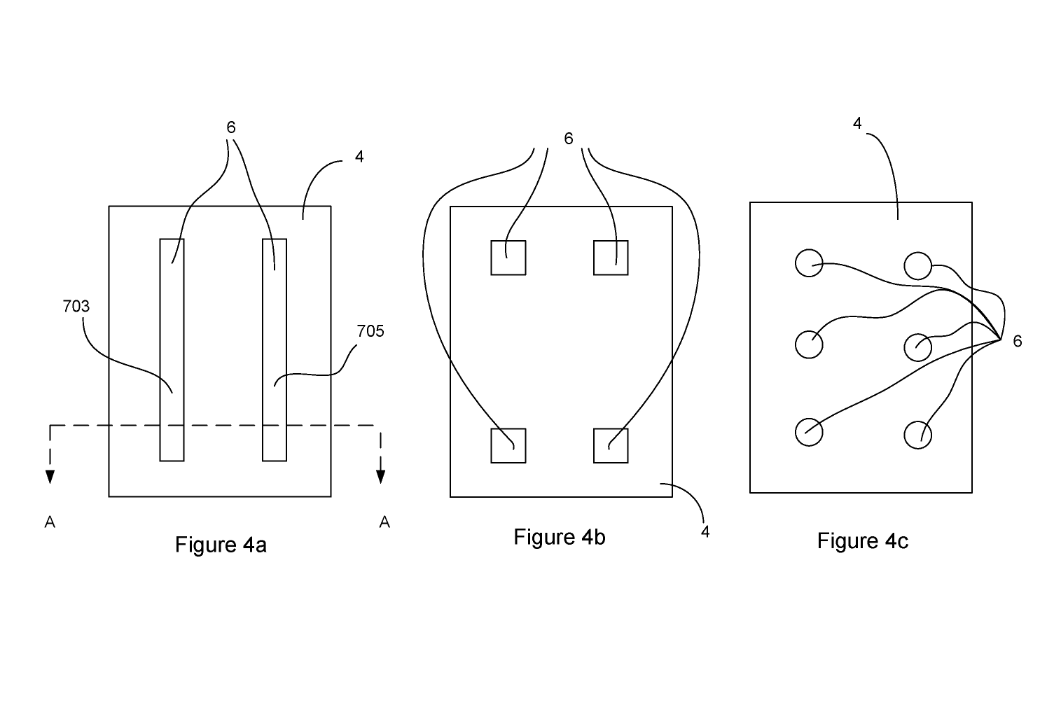

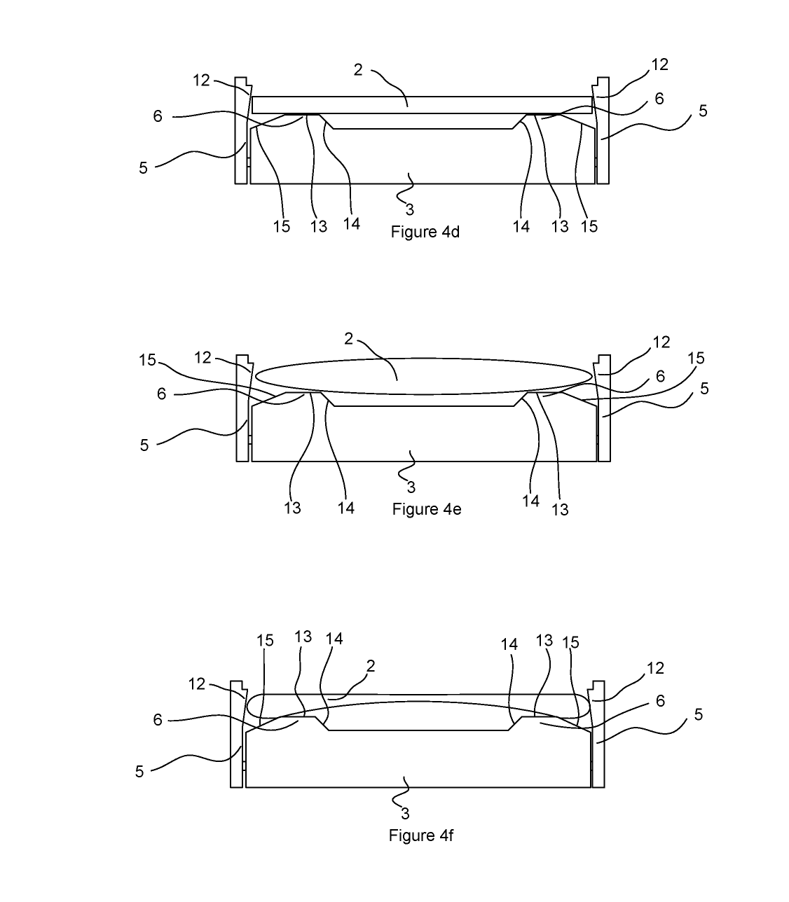

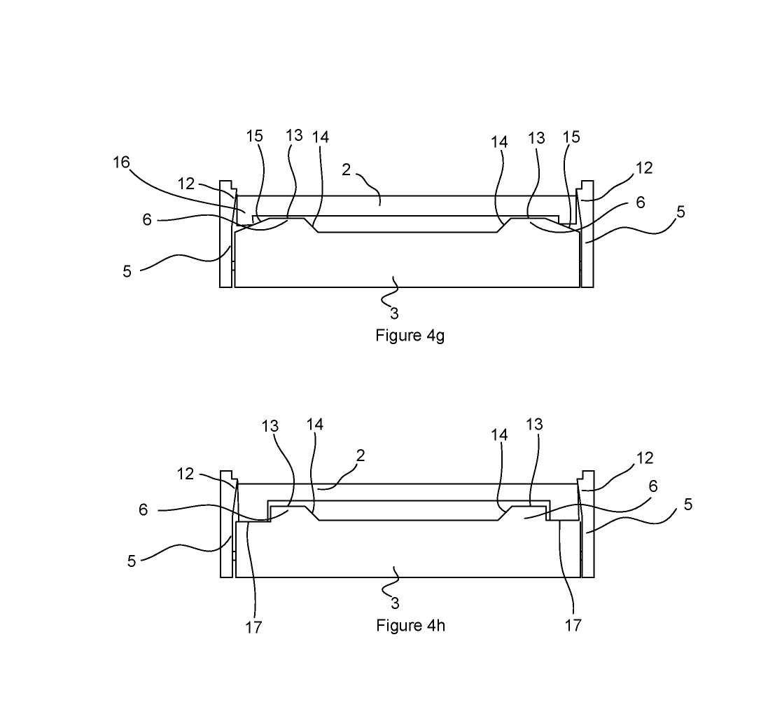

FIGS. 4a to 4c show examples of possible configurations of formations.

FIG. 4a shows two formations which are parallel ribs 6, disposed symmetrically about the interface surface, near the outer edges of the interface surface. The ribs may have a square, rectangular or curved cross-section. The profile of the ribs may include one or more tapers, at one or both the top and bottom ends of the ribs.

FIG. 4b shows four formations in the form of pads 6 which are disposed at the lower and upper ends of the interface surface. This arrangement of formations may provide centralisation of the mobile device in both longitudinal and lateral directions.

FIG. 4c shows six formations, in the form of semi-hemispherical bumps having a semi-circular cross-section, disposed in straight lines symmetrically about the interface surface, near the outer edges of the interface surface.

FIGS. 4d to 4g show cross sectional views of mounting mechanisms according to one embodiment of the invention, showing how different mobile device shapes interact with the formations.

FIG. 4d shows the mounting of a substantially flat mobile device 2 with a rectangular cross-section. The formations 6 have trapezoidal cross sections, comprising a central section 13 and an outer ramp section 15 sloping towards the edges of the mounting mechanism 1. The formations 6 also include inner ramp sections 14 sloping towards opposite ribs. The arms 5 clamp the mobile device 2 from either side, centralising the mobile device 2. The mobile device rests on top of the formations 6 on the flat part of the formations 6. The distal ends 12 of the arms 5 are inwardly inclined to urge the mobile device 2 towards the rangefinder 3 and secure the mobile device 2 in place.

FIG. 4e shows the mounting of a substantially curved mobile device 2 with an ovular cross-section. The arms 5 clamp the mobile device 2 from either side. The inner ramp sections 14 of the formations 6 partially cradle the curved portion (having a positive incline) of the lower part of the mobile device 2, ensuring that the mobile device is centralised and not titled with respect to the interface surface.

FIG. 4f shows the mounting of a mobile device 2 having a concave interface surface. The arms 5 clamp the mobile device 2 from either side. The formations 6 are disposed within the recess of the mobile device 2, and ensure that the mobile device 2 is centralised with respect to the rangefinder 3. The camera optical axis and rangefinder optical axis are kept substantially parallel as the curved portions of the mobile device 2 rest on the angled outer ramp sections 15 of the formations 6.

FIG. 4g shows the mounting of a mobile device 2 with a raised outer rim 16. The angled ramps of ribs 6 evenly support the rims of mobile device 2 for a range of rim spacings.

FIG. 4h shows an alternative embodiment in which each formation 6 has an outer flat platform 17, lower than the central section 13, instead of outwardly inclined ramp sections 15. The outer flat platforms 17 support the rim 16 of the mobile device.

The position of the formations also depends on the range of mobile device shapes (e.g. curvature) and/or sizes to which the mounting mechanism is to attach. The height of the formations may desirably be between 2 mm to 4 mm. However, the optimal height of these may depend on the range of device sizes which are to be accommodated. The space between the inside edges of the formations may desirably span between 20 mm to 70 mm. The space between the outside edges of the formations may span between 40 to 75 mm.

Formations may be integrally formed with the interface surface of the mounting mechanism, they may be permanently secured to the interface surface of the mounting mechanism, or they may be releasably attached to the interface surface of the mounting mechanism. A releasable attachment may be advantageous in allowing different formations to be added to/removed from the interface surface optimised for different mobile device shapes, sizes and/or configurations.

In addition to formations, an edge guide may also be included on the mounting mechanism to guide the position of the mobile device relative to the mounting mechanism.

### Arms

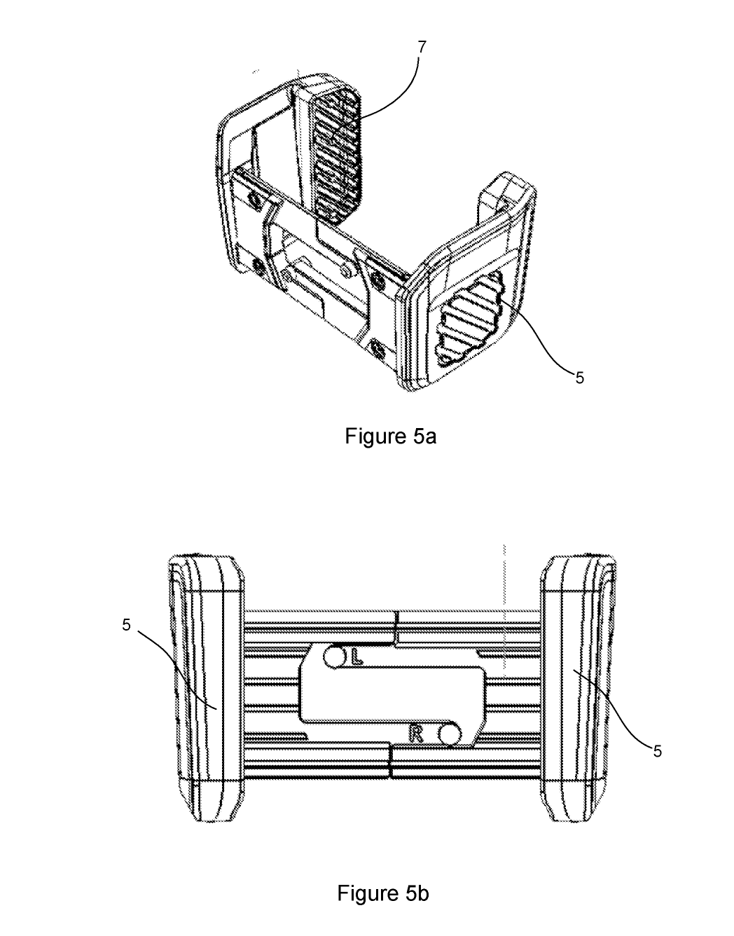

FIG. 5a shows a perspective view of arms 5 of the mounting mechanism. FIG. 5b shows a front view of the arms shown in FIG. 5a. The arms may be moved synchronously towards each other to clamp a mobile device engaged with the interface surface so as to maintain the mobile device centralised with respect to the interface surface.

Preferably the arms move synchronously and uniformly towards and away from each other. Any suitable mechanism may be used to achieve this. Examples include a rack and pinion or a piston and spring mechanism, which will be discussed in more detail below.

In a released position, the arms are expanded to their maximum extent, as shown in FIGS. 3a to 3c. When securing the mounting mechanism to a particular mobile device, a user places the mobile device against the interface surface and squeezes the arms together to clamp the arms around the mobile device. A button may be provided which the user may press to expand (i.e. release) the arms from the gripping position. Other release mechanisms may include pushing the arms themselves inwards to release them, or simply pulling the arms with sufficient force.

An inner surface 7 of the arms preferably includes a gripping material/surface to hold the mobile device securely. For example, the material may be a solid rubber. The inner surface 7 of the arms may be textured to provide grip.

To maintain uniform movement of the arms, an arm centralisation mechanism is used to control the position of the arms clamping in a particular direction. For example, a ratchet mechanism may be used in a rack and pinion arrangement. This involves a linear rack with teeth attached to each arm in combination with a round, centralised gear. To prevent unwanted separation of the arms, the gear may beshaped asymmetrically so that the teeth have a moderate slope on one side and a steep slope on the other. This causes the forward, clamping direction to be unrestricted, but the reverse direction will cause the teeth to catch against the steep slope, locking the mechanism. To release the clamp, a button disengages the mechanism.

An alternative embodiment may use a piston and spring mechanism. This also maintains uniform movement and clamps securely. Uniform springs are attached to each clamping arm. To clamp a device, the arms are separated and the springs extended. The device is then placed between the arms and held in place by the springs under tension. To release the device, the arms are separated again.

The mounting mechanism may include any suitable number of arms. In the shown embodiments, the mechanism includes two arms, one on either side of the mobile device. In other embodiments, two sets of arms (four in total) may be provided, one set gripping a lower end of a mobile device, and the other set gripping an upper end of the mobile device.

In the shown embodiments the arms grip transversely, across the width of the mobile device however the invention is not limited in this respect. One or more arms may be included to secure the mobile device in a longitudinal manner, along the height of the device. In yet further embodiments, arms may be included to secure the mobile device both transversely and longitudinally.

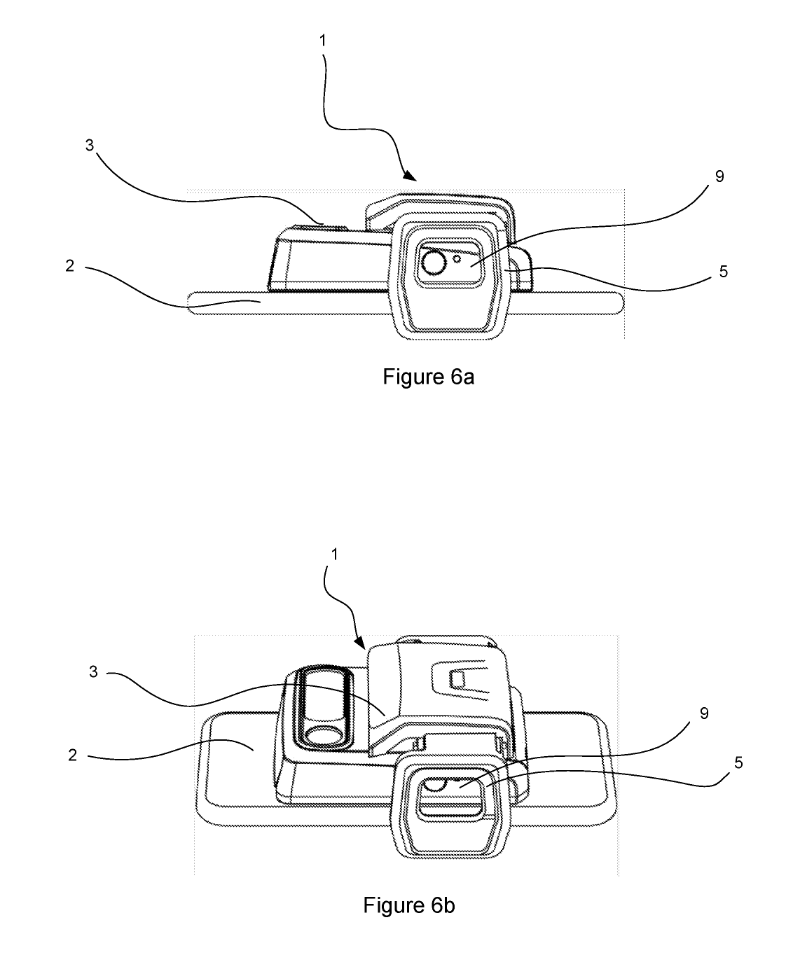

FIG. 6a shows a side view of a mounting mechanism mounted to a mobile device and rangefinder according to another embodiment of the invention. FIG. 6b shows a perspective view of a mounting mechanism of FIG. 6a. The arms 5 of the mounting mechanism of this embodiment include apertures 9. These apertures may provide access to buttons, jacks and/or other features on the rangefinder and/or mobile device. Preferably the size and shape of the aperture is optimised to allow as much access as possible to features on various mobile device models/rangefinder models.

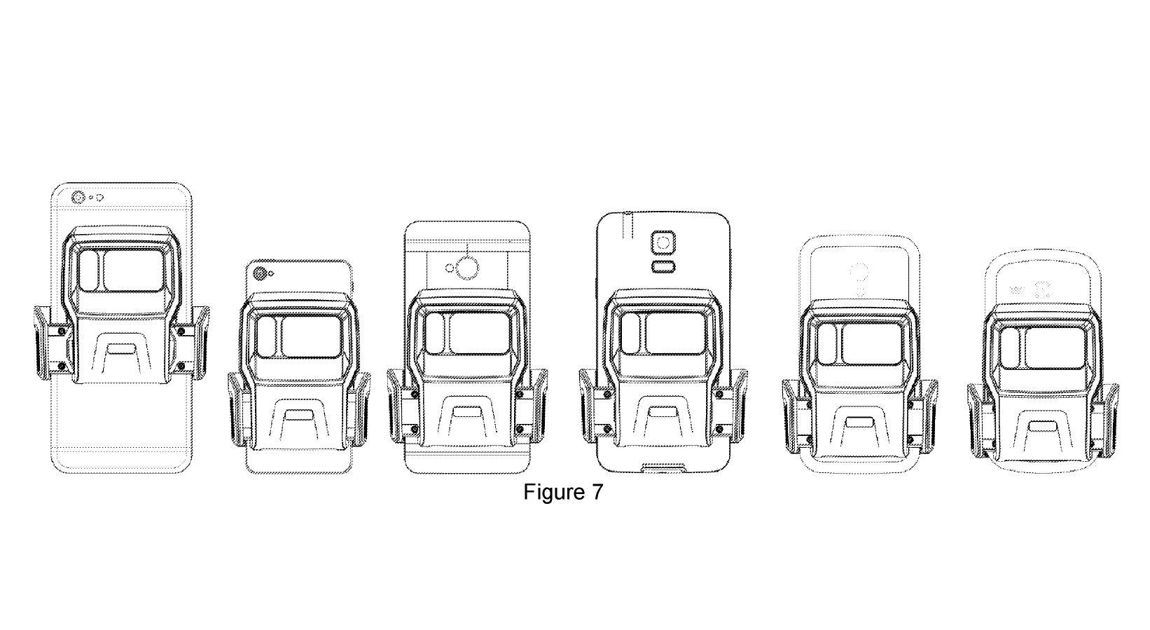

FIG. 7 shows front views of attachment of a mounting mechanism to a range of different mobile devices. For each mobile device, the amount by which the arms 5 are extended depends on the width of the mobile device 2. In each case the formations on the interface surface of the mounting mechanism maintains the surfaces of the mobile devices substantially parallel to the surfaces of the rangefinders 3, and thus maintains the optical axes of the mobile device cameras substantially parallel to the optical axes of the rangefinders.

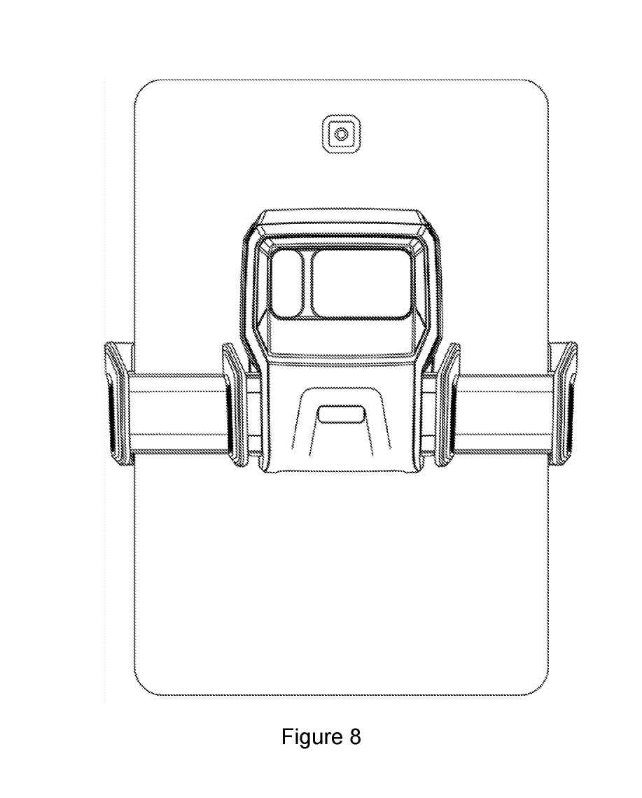

FIG. 8 shows a front view of attachment of a mounting mechanism to a particular large mobile device (for example a tablet) according to an embodiment of the invention.

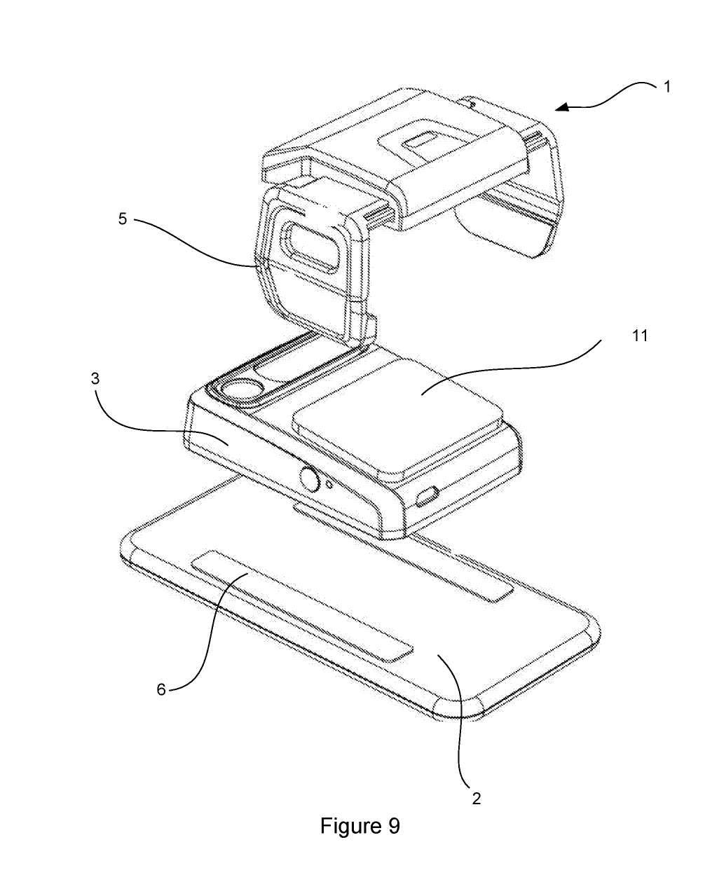

FIG. 9 shows an exploded view of a mounting mechanism according to an embodiment of the invention. The mounting mechanism may be attached to the rangefinder in a number of different ways. In the embodiment shown in FIG. 9 the rangefinder attaches to the mounting mechanism with adhesive 11. In other embodiments, the mounting mechanism may be integrally formed with the rangefinder. Alternatively, a mechanical coupling mechanism may be used to secure the rangefinder to the mounting mechanism (for example a snap fit). Alternatively the clamping mechanism may include a housing accommodating the rangefinder.

In the embodiment shown in FIG. 9, as the mounting mechanism is not integrally formed with the rangefinder, the formations 6 are disposed directly between the mobile device 2 and the rangefinder 3, rather than being on an interface surface of the mounting mechanism.

The invention thus provides an improved mounting mechanism for mounting a mobile device to a rangefinder. The mounting mechanism provides a releasable connection between the rangefinder and a wide range of mobile devices. The orientation and/or position of the mobile device relative to the rangefinder is maintained in an optimal position by the mounting mechanism in order to ensure accurate measurements.

In particular, the mobile device is centralised relative to the mobile devices as the mounting mechanism aligns the range finder optical axis with the optical axis of the mobile device's camera. The invention mounts mobile devices relative to rangefinders with the correct angular and lateral alignment for a variety of phone shapes and/or sizes.

While the present invention has been illustrated by the description of the embodiments thereof, and while the embodiments have been described in detail, it is not the intention of the Applicant to restrict or in any way limit the scope of the appended claims to such detail. Further, the above embodiments may be implemented individually, or may be combined where compatible. Additional advantages and modifications, including combinations of the above embodiments, will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

1. A mounting mechanism for mounting an auxiliary device to a mobile device, the mounting mechanism including:
an interface surface having formations positioned such as to engage with a surface of the mobile device so as to maintain the mobile device in a desired orientation relative to the auxiliary device; and
two or more arms that may be moved synchronously towards each other to clamp a mobile device engaged with the interface surface so as to maintain the mobile device centralised with respect to the interface surface.

2. The mounting mechanism of claim 1 wherein the mobile device includes a camera with a camera optical axis and wherein the auxiliary device is a rangefinder having a rangefinder optical axis and the interface surface has formations positioned such as to engage with a surface of the mobile device so as to maintain the camera optical axis generally parallel with the rangefinder optical axis.

3. The mounting mechanism of claim 1 wherein the mobile device includes a camera with a camera optical axis and wherein the auxiliary device includes a laser pointer having a laser optical axis and the interface surface has formations positioned such as to engage with a surface of the mobile device so as to maintain the camera optical axis generally parallel with the laser optical axis.

4. The mounting mechanism of claim 1 wherein the mobile device includes a camera with a camera optical axis and wherein the auxiliary device is an acoustic sensor having an acoustic axis and the interface surface has formations positioned such as to engage with a surface of the mobile device so as to maintain the camera optical axis generally parallel with the acoustic axis.

5. The mounting mechanism of claim 1 wherein the mobile device includes a camera with a camera optical axis and wherein the auxiliary device includes an orientation sensor having an orientation axis and the interface surface has formations positioned such as to engage with a surface of the mobile device so as to maintain the camera optical axis generally parallel or normal to the orientation axis.

6. The mounting mechanism of claim 2 wherein the formations are arranged on the interface surface so as to maintain the rangefinder optical axis substantially parallel with the camera optical axis for a range of mobile device profiles.

7. The mounting mechanism of claim 6 wherein the mobile device profiles include two or more of a convex profile; concave profile; and a flat profile.

8. The mounting mechanism of claim 1 wherein the interface surface has formations positioned such as to engage with a surface of the mobile device and wherein the formations include two parallel ribs.

9. The mounting mechanism of claim 8 wherein each rib has a central section and an outer ramp section sloping towards edges of the mounting mechanism.

10. The mounting mechanism of claim 8 wherein each rib has a central section and an outer flat platform, lower than the central section.

11. The mounting mechanism of claim 8 wherein each rib has an inner ramp section sloping towards an opposite rib.

12. The mounting mechanism of claim 8 wherein the ribs are between 2 to 4 mm high.

13. The mounting mechanism of claim 8 wherein opposite inner edges of the ribs are spaced between 20 mm to 70 mm apart.

14. The mounting mechanism of claim 1 wherein the interface surface has formations positioned such as to engage with a surface of the mobile device and wherein the formations include a plurality of symmetrically arranged pads.

15. The mounting mechanism of claim 1 wherein the two or more arms move synchronously by a rack and pinion mechanism.

16. The mounting mechanism of claim 1 wherein the two or more arms move synchronously by a piston and spring mechanism.

17. The mounting mechanism of claim 1 wherein the arms are retained in engagement when clamped upon a mobile device and released by a release mechanism.

18. The mounting mechanism of claim 17 wherein the release mechanism is activated by one of: a release button; further forcing the clamp arms together; and forcing the clamp arms apart with a force greater than a release threshold force.

19. The mounting mechanism of claim 1 wherein each arm inclines towards the other towards its distal end to assist retention of a mobile device.

20. The mounting mechanism of claim 1 wherein the interface surface has formations positioned such as to engage with a surface of the mobile device and wherein the formations are formed of a resilient material.

21. The mounting mechanism of claim 2 including a housing encasing the rangefinder.
